(19) United States
(12) Patent Application Publication
(10) Pub. No.: US 2009/0249204 A1
(43) Pub. Date: Oct. 1, 2009

(54) FILE MANAGEMENT SYSTEM, MOBILE TERMINAL, AND COMPUTER-READABLE RECORDING MEDIUM RECORDING MOBILE TERMINAL PROGRAM

(75) Inventor: Masatoshi Sugiura, Nishio-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/405,827

(22) Filed: Mar. 17, 2009

(30) Foreign Application Priority Data
Mar. 27, 2008 (JP) 2008082360

(51) Int. Cl. G06F 17/30; G06F 3/048

(52) U.S. Cl. 715/708; 707/10; 707/201; 707/E17.032

(57) ABSTRACT

A file management system includes a file server with a file storage device storing a file associated with an update date and time of the file and a mobile terminal with a file information output device to output information of the file, wherein the mobile terminal comprises a file obtaining device that obtains the file and the update date and time, and an obtained list information creation device that creates obtained list information associating the file identification information with the update date and time of the file, and an update information output device in the file server outputs update information indicating the file has been updated, if the update date and time about the file is less recent than the update date and time stored in the file storage device, and an update display control device in the mobile terminal displays a message informing the file has been updated if the update information is received.

### CROSS-REFERENCE TO RELATED APPLICATION

The present application claims priority from Japanese Patent Application No. 2008-082360, which was filed on Mar. 27, 2008, the disclosure of which is herein incorporated by reference in its entirety.

### BACKGROUND

The present disclosure relates to a file management system, a mobile terminal, and a computer-readable recording medium recording a mobile terminal program. More specifically, the present disclosure relates to a file management system constituted of a file server and a mobile terminal that obtains and uses files stored in the file server, the mobile terminal, and a computer-readable recording medium recording a mobile terminal program.

Recently, document management has been considered to be important in order to comply with the financial products trading law (so-called JSOX Act) and the Company Law or strengthen internal control. For this purpose, a variety of management methods and systems have been proposed to manage documents. For example, according to a history management method described in Japanese Patent Application Laid-Open No. 2002-82934, a history is recorded of operations performed on the original of a document, by which that document original would be moved together with the operation history, thus the history of the document is managed. Further, according to a content copy tracking management system described in Japanese Patent Application Laid-Open No. 2002-16788, an ID is assigned to a document and incorporated in the document as an electronic watermark. Then, if the document is copied on a copy machine, the copy machine reads the ID from the electronic watermark and transmits the read ID to a content ID management center. The content ID management center in turn manages the history of copying the document.

Further, a user of a portable terminal has conventionally stored content (for example, documents, images, pictures, and voices) in the portable terminal to watch and listen to it. To store content in the portable terminal, a method has been employed for connecting the terminal to a network and downloading (copying) the content from a server located in the network. When using content obtained from the server in the network, a user usually makes the portable terminal offline (disconnected from the network).

### SUMMARY

However, if a portable terminal is being used offline, any modification or deletion of content on the server side is not recognized on the portable terminal side. Accordingly, the user of the portable terminal may use the content without knowing it has been modified or deleted. The history management method described in Japanese Patent Application Laid-Open No. 2002-82934 and the content copy tracking management system described in Japanese Patent Application Laid-Open No. 2002-16788 manage content itself (an original) but do not take into account reflecting modifications in the copied content.

The present disclosure has been developed to solve these problems, and it is an object of the present disclosure to provide a file management system that reflects or helps to reflect a change in state of a file on a file server in a mobile terminal which is used offline, the mobile terminal, and a computer-readable recording medium recording a mobile terminal program.

To solve the problems described above, in a first aspect of this disclosure, a file management system includes a file server equipped with a file storage device that stores a file associated with an update date and time of the file, and a mobile terminal that has a file information output device to output information described in the file and that is connected to the file server, wherein the file server includes a server-side connection device that is connected to the mobile terminal, and a file output device that outputs the file stored in the file storage device to the mobile terminal through the server-side connection device together with the update date and time, the mobile terminal includes a display device that displays information, a mobile terminal-side connection device that is connected to the file server, a file obtaining device that is connected to the file server through the mobile terminal-side connection device, to obtain the file and the update date and time which have been output from the file output device, an obtained file storage device that stores the file and the update date and time which have been obtained by the file obtaining device, an obtained list information creation device that creates obtained list information in which file identification information to identify the file stored in the file storage device and the update date and time of the file are associated with each other, and an obtained list information output device that outputs the obtained list information created by the obtained list information creation device to the file server, the file server further includes an obtained list information obtaining device that, if the mobile terminal is connected thereto via the server-side connection device, obtains the obtained list information from the mobile terminal, and an update information output device that, if the update date and time of the obtained list information about the file identified by the file identification information in the obtained list information obtained by the obtained list information obtaining device is less recent than the update date and time stored in the file storage device, outputs update information which indicates that the file has been updated, to the mobile terminal, and the mobile terminal further includes an update display control device that, if having received the update information output from the update information output device in the file server, causes the display device to display a message to the effect that the file indicated by the update information has been updated.

To solve the problems described above, in a second aspect of this disclosure, a mobile terminal includes a display device that displays information, a mobile terminal-side connection device that is connected to a file server equipped with a file storage device that stores a file associated with an update date and time of the file, a file obtaining device that is connected to the file server through the mobile terminal-side connection device, to obtain the file and the update date and time which have been output from the file output device, an obtained file storage device that stores the file and the update date and time which have been obtained by the file obtaining device, an obtained list information creation device that creates obtained list information in which file identification information to identify the file stored in the file storage device and the update date and time of the file are associated with each other, an obtained list information output device that outputs the obtained list information created by the obtained list information creation device to the file server, an update display control device that, if having received the update information which has been created by the file server based on the obtained list information output from the obtained list information output device and which indicates that the file output has been updated, causes the display device to display a message to the effect that the file indicated by the update information has been updated, and a file information output device that outputs the information described in the file to the display device.

To solve the problems described above, in a third aspect of this disclosure, a computer program product includes a computer-readable medium recording computer readable instructions, wherein execution of the computer readable instructions causes a controller of a mobile terminal having a display device to perform the step of connecting the mobile terminal to a file server equipped with a file storage device that stores a file associated with an update date and time of the file, obtaining the file and the update date and time from the file server, storing the file and the update date and time which have been obtained, creating obtained list information in which file identification information to identify the file stored in the file storage device and the update date and time of the file are associated with each other, outputting the obtained list information to the file server, if having received the update information which has been created by the file server based on the obtained list information and which indicates that the file output has been updated, causing the display device to display a message to the effect that the file indicated by the update information has been updated and outputting the information described in the file to the display device.

Other objects, features, and advantages of the present disclosure will be apparent to persons of ordinary skill in the art in view of the following detailed description of embodiments of the invention and the accompanying drawings.

### BRIEF DESCRIPTION OF THE DRAWINGS

Exemplary embodiments of the invention will be described below in detail with reference to the accompanying drawings in which:

FIG. 1 is a configuration diagram of a file management system according to an embodiment of the present disclosure;

FIG. 2 is a schematic diagram showing an electrical configuration of a file server;

FIG. 3 is a schematic view showing a configuration of a content information storage area;

FIG. 4 is a schematic view showing a configuration of an operation history list storage area;

FIG. 5 is a schematic view showing a configuration of a storage area for a last connected date and time information;

FIG. 6 is a schematic view showing a configuration of storage areas arranged in an RAM;

FIG. 7 is a schematic view showing a configuration of an output content file storage area in the RAM;

FIG. 8 is a schematic diagram showing an electrical configuration of a mobile terminal;

FIG. 9 is a schematic view showing a configuration of storage areas arranged in a flash memory;

FIG. 10 is a schematic view showing a configuration of an obtained list information storage area in the flash memory;

FIG. 11 is a flowchart of update processing;

FIG. 12 is a flowchart of deletion processing;

FIG. 13 is a flowchart of terminal connection processing;

FIG. 14 is a flowchart of transfer processing which is performed in the terminal connection processing;

FIG. 15 is a flowchart of terminal-unconnected warning processing;

FIG. 16 is a flowchart of server connection processing;

FIG. 17 is a flowchart of reception processing which is performed in the server connection processing;

FIG. 18 is a flowchart of disconnection processing; and

FIG. 19 is a flowchart of server connection processing according to a modification.

### DETAILED DESCRIPTION OF EMBODIMENTS

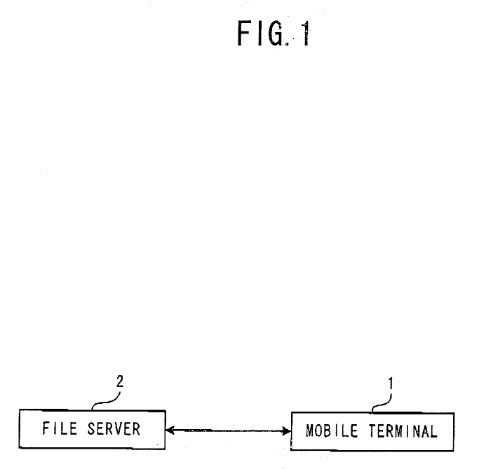

A description will be given of an embodiment according to the present disclosure with reference to the drawings. As shown in FIG. 1, in a file management system according to the present embodiment, a mobile terminal 1 is connected to a file server 2. The mobile terminal 1 is connected to the file server 2 to obtain a content file. The content file is a collection of data pieces in which content is written. The content may be comprised of at least one of a character and an image. A file management program is stored in the file server 2. If the file management program is executed at the file server 2, a file management application is started. The file management application can select a content file to be output to the mobile terminal 1, from among the content files that can be obtained by the file server 2. When the mobile terminal 1 is connected to the file server 2, the selected content file is output by the file management application from the file server 2 to the mobile terminal 1.

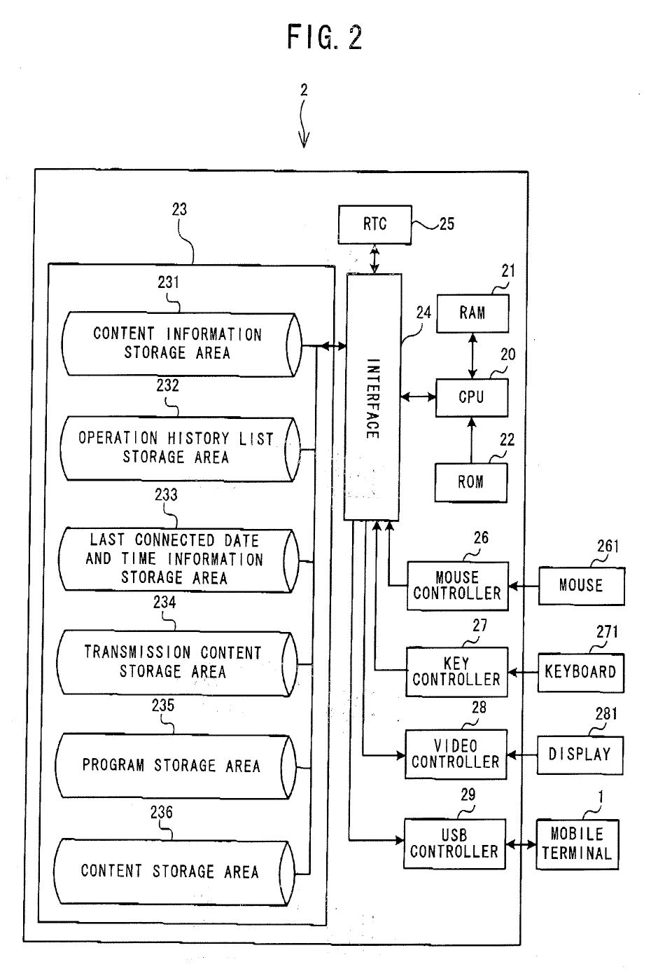

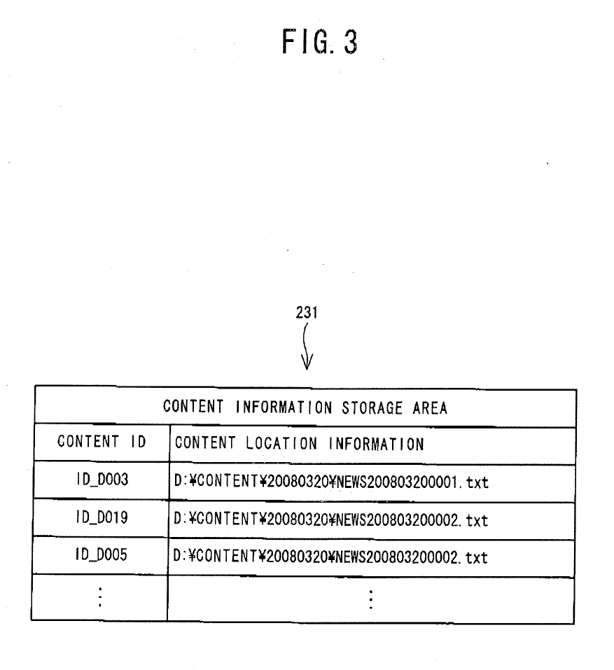

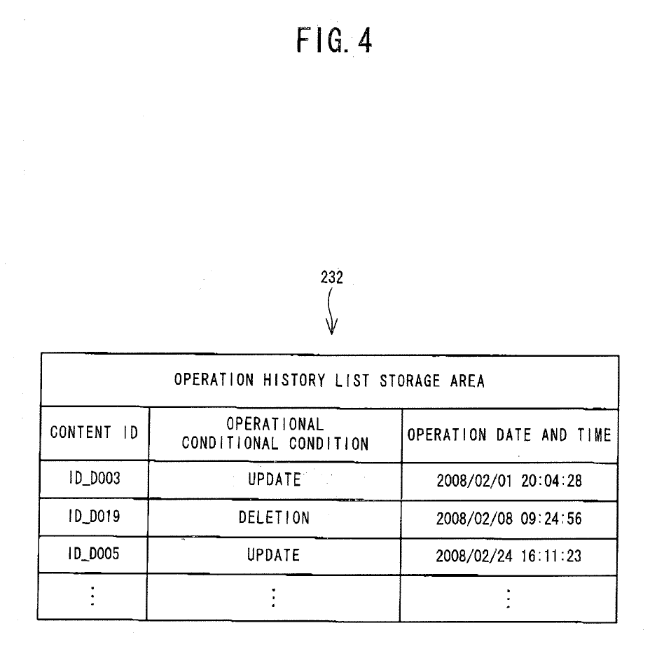

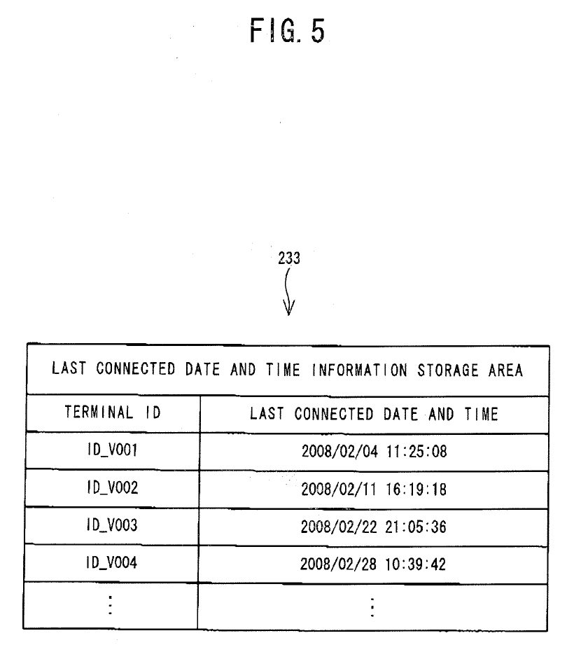

Next, a description will be given of an electrical configuration of the file server 2 with reference to FIG. 2. As shown in FIG. 2, the file server 2 includes a CPU 20 that conducts control over the file server 2. To the CPU 20 are connected an RAM 21 which stores various kinds of data temporarily, an ROM 22 which stores BIOS etc. beforehand, and an I/O interface 24 which mediates the delivery and receipt of data. To the I/O interface 24 is connected a hard disk apparatus 23. The hard disk apparatus 23 contains at least a content information storage area 231 (see FIG. 3), an operation history list storage area 232 (see FIG. 4), a last connected date and time information storage area 233 (see FIG. 5), a transmission content storage area 234, a program storage area 235, and a content file storage area 236.

It is to be noted that in the content information storage area 231 (see FIG. 3), the location of a content file is stored associated with identification information (content ID) that identifies the content. The operation history list storage area 232 (see FIG. 4) stores the history of operations performed on a content file. The last connected date and time information storage area 233 (see FIG. 5) stores a date and time (last connected date and time information) on which the mobile terminal 1 is last connected to the file server 2, for each identification information (terminal ID) that identifies the mobile terminal 1. The transmission content storage area 234 stores the content ID of a content file which is selected so as to be output when the mobile terminal 1 is connected, for each terminal ID. The program storage area 235 stores beforehand the file management program which is executed by the CPU 20. The content file storage area 236 stores content files beforehand.

Further, to the I/O interface 24 are connected an RTC 25, a mouse controller 26, a key controller 27, a video controller 28, and a USB controller 29. The RTC 25 is used to measure time. A mouse 261, a keyboard 271, and a display 281 are connected to the mouse controller 26, the key controller 27, and the video controller 28, respectively. The mobile terminal 1 is connected to the USB controller 29 via a USB cable (not shown).

Next, a description will be given of the storage areas arranged in the hard disk apparatus 23 of the file server 2 with reference to FIGS. 3 to 5. First, the content information storage area 231 will be described with reference to FIG. 3. In the content information storage area 231, the location of a content file is stored associated with identification information (content ID) that identifies the content. As shown in FIG. 3, the content information storage area 231 has data items “Content ID” and “Content location information”, the content location information that indicates the location of a content being stored therein corresponding to its content ID. The content location information indicates a content file stored in the content file storage area 236 in the file server 2.

Next, the operation history list storage area 232 will be described with reference to FIG. 4. The operation history list storage area 232 stores a history of operations performed on a content file. As shown in FIG. 4, the operation history list storage area 232 stores data items “Content ID”, “Operations”, and “Operation date and time”. If a content file is updated or deleted, a new record is added. In an example shown in FIG. 4, a record is stored of a history that a content file having content ID “ID_D003” was updated at 20:04:28 on Feb. 1, 2008. Another record is stored of a history that a content file having content ID “ID_D019” was deleted at 09:24:56 on Feb. 8, 2008. A yet another record is stored of a history that a content file having content ID “ID_D005” was updated at on Feb. 24, 2008.

Next, the last connected date and time information storage area 233 will be described with reference to FIG. 5. In the last connected date and time information storage area 233, a date and time (last connected date and time) on which the mobile terminal 1 was last connected to the file server 2 is stored for each piece of identification information (terminal ID) that identifies the mobile terminal 1. As shown in FIG. 5, the last connected date and time information storage area 233 has data items “Terminal ID” and “Last connected date and time”, which store a date and time on which each mobile terminal 1 was last connected to the file server 2.

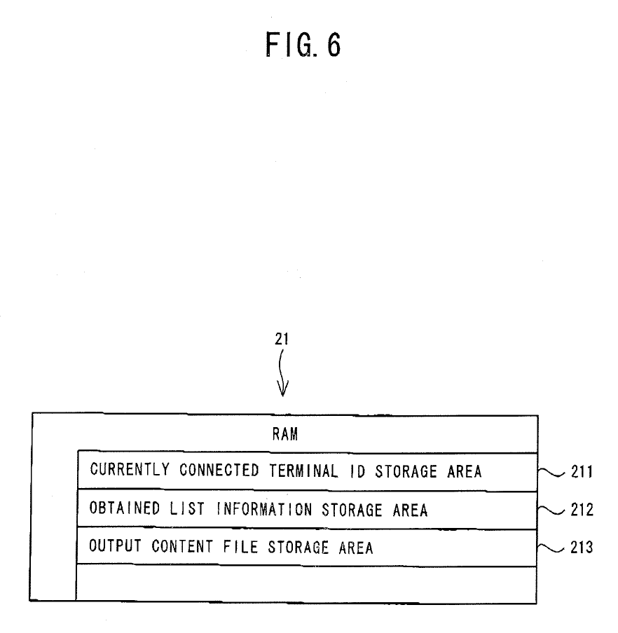

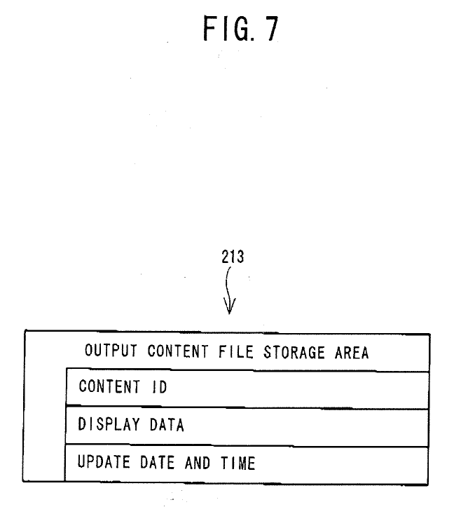

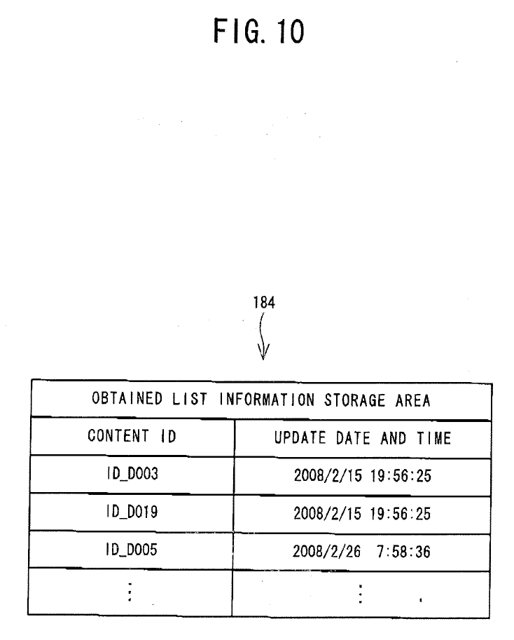

Next, a description will be given of the storage areas arranged in the RAM 21 in the file server 2 with reference to FIGS. 6 and 7. As shown in FIG. 6, the RAM 21 has at least a currently connected terminal ID storage area 211, an obtained list information storage area 212, and an output content file storage area 213. It is to be noted that the RAM 21 may have storage areas other than those shown in the figure as required. The currently connected terminal ID storage area 211 stores the terminal ID of the mobile terminal 1 connected to the file server 2. The obtained list information storage area 212 stores the information of a list obtained from the mobile terminal 1 connected (see FIG. 10).

The output content file storage area 213 stores data which is created when a content file is output from the file server 2 to the mobile terminal 1. Hereinafter, a file which is created to output a content file from the file server 2 to the mobile terminal 1 is referred to as an “output content file”. The “output content file” is stored in the output content file storage area 213. An output content file is comprised of data items “Content ID”, “Display data”, and “Update date and time”. The “Content ID” is used to set therein the content ID of a content file selected to be output. The “Display data” is used to store therein display data which is reconfigured into a format in which content described in a content file can be displayed at the mobile terminal 1. The “Update date and time” is used to store therein the current date and time.

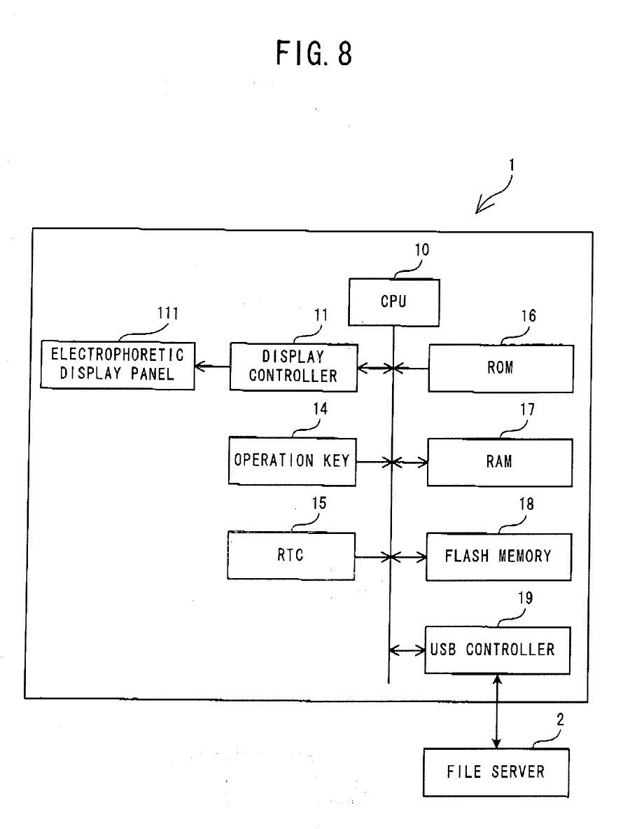

Next, the electrical configuration of the mobile terminal 1 will be described with reference to FIG. 8. As shown in FIG. 8, the mobile terminal 1 comprises a CPU 10, a display controller 11, an operation key 14, a real-time clock (RTC) 15, a ROM 16, a RAM 17, a flash memory 18, and a USB controller 19. The CPU 10 conducts control over the mobile terminal 1. The ROM 16 stores beforehand various kinds of information and a display terminal program to operate the mobile terminal 1. The RAM 17 is a memory that temporarily stores various kinds of data and the flash memory 18 is a nonvolatile memory that stores various kinds of information. The display controller 11 controls the display of information on an electrophoretic display panel 111. The RTC 15 is used to measure time. The USB controller 19 connects the mobile terminal 1 to the file server 2 via a USB cable (not shown).

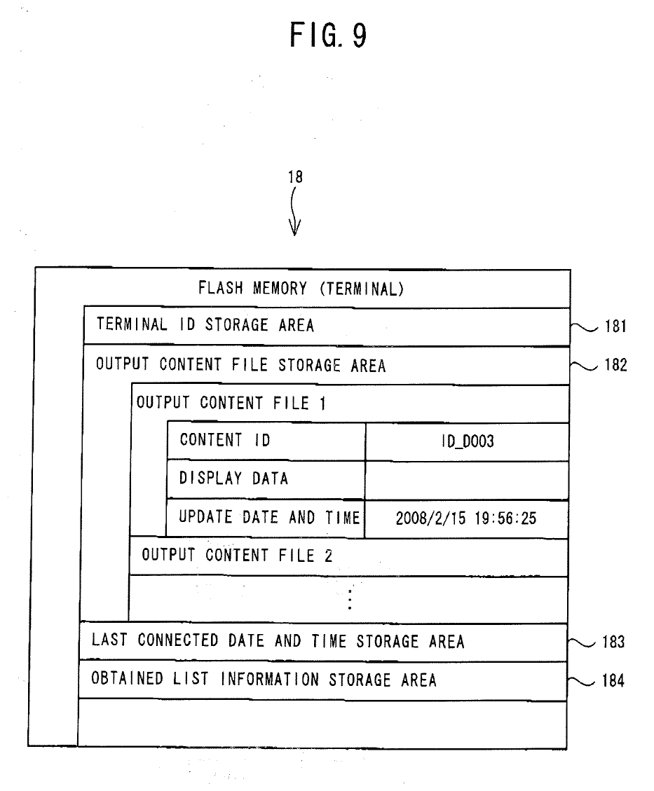

Next, the flash memory 18 will be described with reference to FIGS. 9 and 10. As shown in FIG. 9, the flash memory 18 has at least a terminal ID storage area 181, an output content file storage area 182, a last connected date and time storage area 183, and an obtained list information storage area 184 (see FIG. 10). The terminal ID storage area 181 stores a unique terminal ID as identification information that identifies the relevant mobile terminal 1. The output content file storage area 182 stores an output content file (see the output content file storage area 213 in FIG. 7) as it is obtained from the file server 2. Therefore, each output content file has the same data items as those of an output content file stored in the output content file storage area 213 (see FIG. 7) and stores the same information. Thus, it is comprised of data items “Content ID”, “Display data”, and “Update date and time”. The last connected date and time storage area 183 stores a date and time when the mobile terminal was disconnected from the file server 2 as a “last connected date and time”. The obtained list information storage area 184 (see FIG. 10) stores the content ID and the update date and time of a content indicated by an output content file stored in the output content file storage area 182. As shown in FIG. 10, the content ID and the update date and time are stored associated with each other.

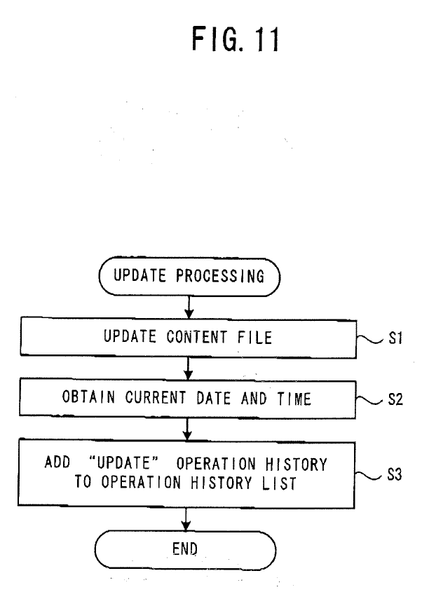

Next, a description will be given of processing which is performed in the file server 2 with reference to FIGS. 11 to 15. First, update processing will be described with reference to FIG. 11. This update processing is performed in the file server 2 when an update program is executed by the CPU 20. This update program, which is part of the file management program, is invoked when an instruction is given to update content stored in the content file storage area 236. First, a content file is updated by being overwritten with a new one in the content file storage area 236 (S1). Then, the current date and time is obtained from the RTC 25 (S2). Subsequently, the record of a new operation history is added to the operation history list storage area 232, the content ID of the content file at which an update instruction has been targeted is set to the “Content ID”, a value that indicates “Update” is set in the “Operations”, and the current date and time obtained at S2 is set in the “Operation date and time” (S3). Then, the present processing ends. It is thus possible to store the operation history of “Update” in the operation history list storage area 232.

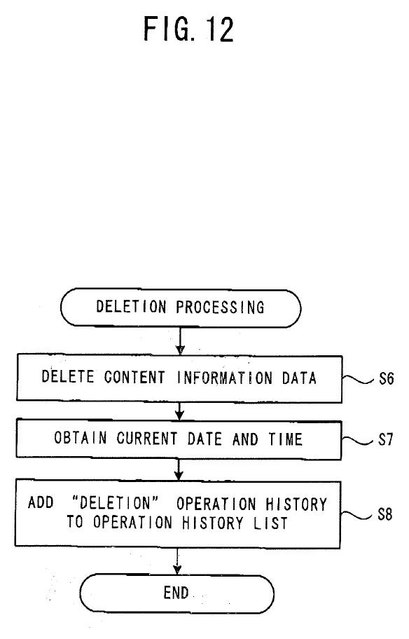

Next, deletion processing will be described with reference to FIG. 12. This deletion processing is performed in the file server 2 when a deletion program in the file management program is executed by the CPU 20. This deletion program is invoked when an instruction is given to delete a content stored in the content file storage area 236. First, a content file at which a deletion instruction is targeted is deleted from the content file storage area 236 (S6). Then, the current date and time is obtained from the RTC 25 (S7). Subsequently, the record of a new operation history is added to the operation history list storage area 232, the content ID of the content file at which a deletion instruction has been targeted is set to the “Content ID”, a value that indicates “Deletion” is set in the “Operation history”, and the current date and time obtained at S7 is set in the “Operation date and time” (S8). Then, the present processing ends. It is thus possible to store the operation history of “Deletion” in the operation history list storage area 232.

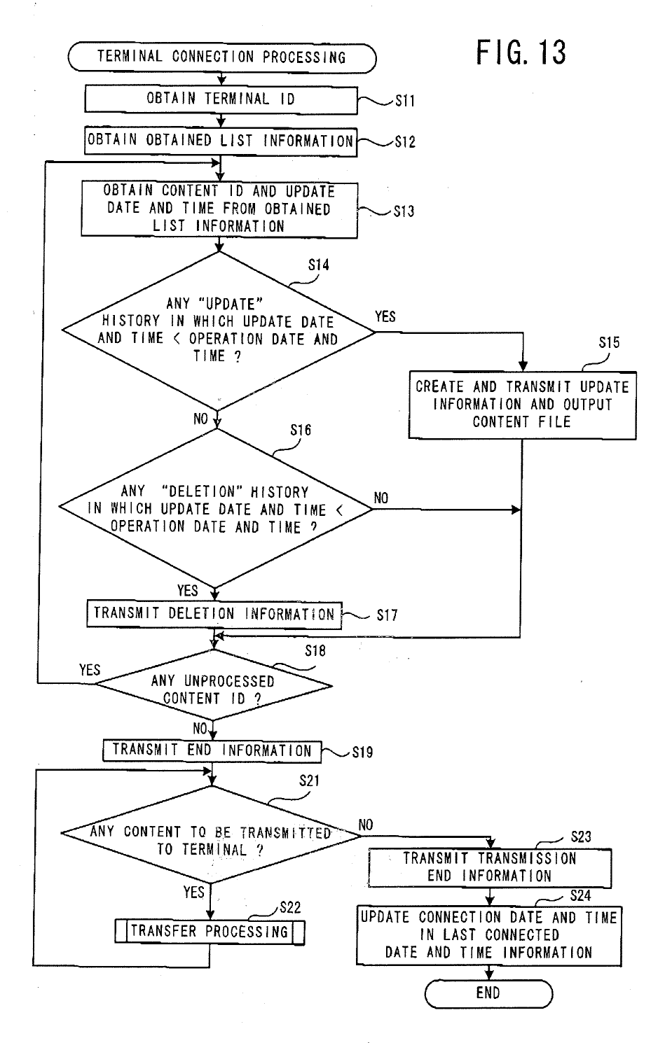

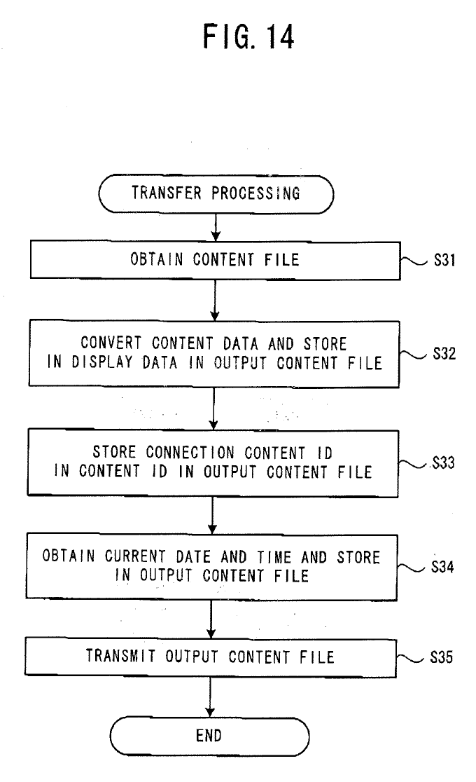

Next, terminal connection processing will be described with reference to FIGS. 13 and 14. This terminal connection processing is performed in the file server 2 when a terminal connection program is executed by the CPU 20. This terminal connection program, which is part of the file management program, is invoked when connection of the mobile terminal 1 is detected.

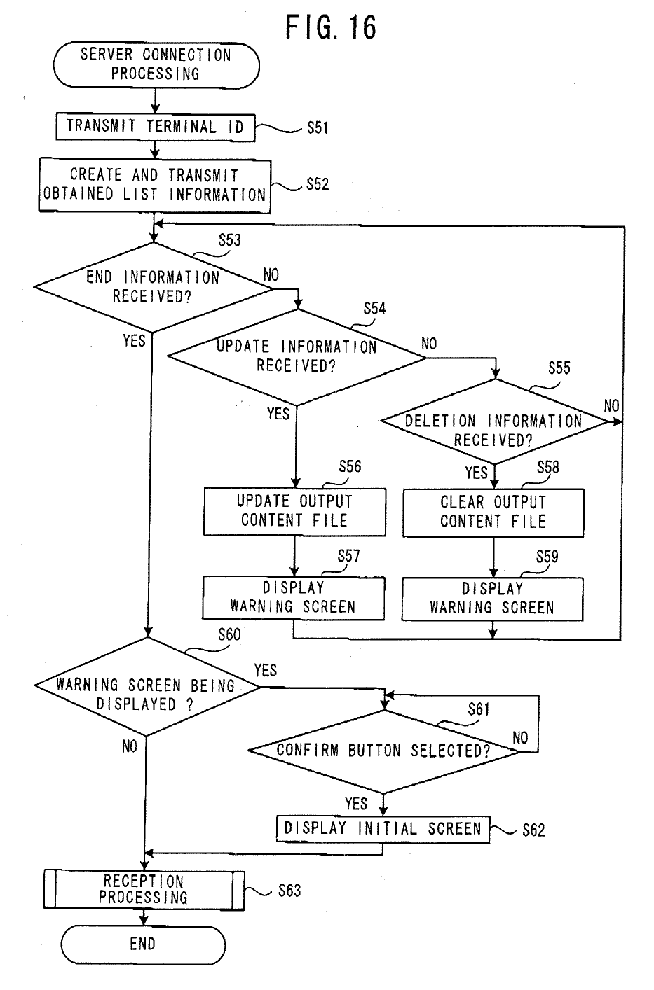

First, the terminal ID of the connected mobile terminal 1 is obtained therefrom and stored in the currently connected terminal ID storage area 211 of the RAM 21 (S11). Hereinafter, the terminal ID stored in the currently connected terminal ID storage area 211 is referred to as a “currently connected terminal ID”. More specifically, the file server 2 receives the terminal ID that is output from the mobile terminal 1 at the moment when it is connected the file server 2 (see S51 in FIG. 16). It is to be noted that information that requests to obtain a terminal ID may be output from the file server 2 to the mobile terminal 1 so that, in response to that request, the mobile terminal 1 outputs to the file server 2 the terminal ID stored in the terminal ID storage area 181 in the flash memory 18. Subsequently, obtained list information is obtained from the connected mobile terminal 1 and stored in the obtained list information storage area 212 in the RAM 21 (S12). More specifically, the file server 2 receives the obtained list information created and output at the moment when the mobile terminal 1 is connected thereto (see S52 in FIG. 16). It is to be noted that also in the obtained list information, the information that requests to obtain may be output from the file server 2 to the mobile terminal 1 so that, in response to that request, the mobile terminal 1 outputs the terminal ID to the file server 2.

Then, one “content ID” and one “update date and time” are obtained from the obtained list information (S13). Then, a determination is made as to whether the operations of the obtained “content ID” has the record of the operation history of “Update” and the “operation date and time” thereof are more recent than the obtained “update date and time” in the operation history list storage area 232 (S14). If there is a record of the operation history having a more recent date and time than the “update date and time” (YES at S14), it means that an output content file obtained by the mobile terminal 1 from the file server 2 has been updated after it was obtained. Therefore, such “update information” as to indicate that it has been updated after being obtained is created, an output content file based on the post-update content file stored in the content file storage area 236 is created, then the output content file is provided to the connected mobile terminal 1 (S15). Then, the processing goes to S18 and, if there is an unprocessed content ID in the obtained list information (YES at S18), returns to S13, where unprocessed “content ID” and “update date and time” are obtained from the obtained list information (S13).

Further, if it is determined at S14 that there is no record of the operation history having a more recent date and time than the “update date and time” (NO at S14), a determination is made as to whether the operations of the obtained “content ID” has the record of the operation history of “deletion”, and the “operation date and time” thereof are more recent than the obtained “update date and time” in the operation history list storage area 232 (S16). If there is a record of the operation history having a more recent date and time than the “update date and time” (YES at S16), it means that an output content file obtained by the mobile terminal 1 from the file server 2 has been deleted after it was obtained. Therefore, “deletion information” which indicates that it has been deleted after being obtained is created and output to the currently connected mobile terminal 1 (S17). Then, the processing goes to S18 and, if there is an unprocessed content ID in the obtained list information (YES at S18), returns to S13, where unprocessed “content ID” and “update date and time” are obtained from the obtained list information (S13).

The processing of S13 to S17 are thus repeated, so that if the content file of a content output to the connected mobile terminal 1 is updated or deleted, information (update information or deletion information) to that effect is transmitted. Moreover, if the content file is already updated, a post-update content file is also reconfigured into an output content file that can be used by the mobile terminal 1 and output.

Subsequently, in the terminal connection processing, to the mobile terminal 1 is transmitted end information that indicates that confirmation processing, which confirms that the content described in the obtained list information has been updated/deleted (S19), has ended. Then, a determination is made as to whether a content ID indicative of a content to be transmitted to the mobile terminal 1 having a “currently connected terminal ID” is stored in the transmission content storage area 234 in the hard disk apparatus 23 (S21). If there is no content to be transmitted (NO at S21), “transmission end information” is transmitted which indicates that no output content file is transmitted (S23). Then, the “last connected date and time” of the currently connected terminal ID is updated (S24). Specifically, the current date and time is obtained from the RTC 25 and stored in the “Last connected date and time” that corresponds to the “currently connected terminal ID” in the last connected date and time information storage areas 233. It is to be noted that if there is no “currently connected terminal ID” in the last connected date and time information storage areas 233, a “currently connected terminal ID” is newly added and the current date and time is stored in the “Last connected date and time”. Then, the terminal connection processing ends.

On the other hand, if there is a content to be transmitted (YES at S21), transfer processing is carried out (see S22 in FIG. 14). Hereinafter, the ID of content to be transmitted is referred to as a “transmission content ID”. As shown in FIG. 14, in the transfer processing, the “Content location information” stored associated with the transmission content ID in the content information storage area 231 is first referenced so as for a content file stored at a location indicated by the content location information to be obtained (S31). Then, data described in the obtained content file is converted into a format that can be used in the mobile terminal 1 and stored in the “Display data” in the output content file storage area 213 (S32). Then, the transmission content ID is stored in the “Content ID” in the output content file storage area 213 (S33) and the current date and time is obtained from the RTC 25 and stored in the “Update date and time” (S34). Then, an output content file stored in the output content file storage area 213 is transmitted to the mobile terminal 1 (S35). Then, the transfer processing ends to return to the terminal connection processing.

As shown in FIG. 13, in the terminal connection processing, a determination is made as to whether there still is a content file to be transmitted to the connected mobile terminal 1 (S21), and if there is any content file to be transmitted (S21), the transfer processing is performed again (S22). Then, the processing of S21, S22 is repeated until the due content files are all transmitted to the connected mobile terminal 1 (NO at S22), whereupon the “transmission end information” that indicates that no output content file is transmitted (S23). Then, the “last connected date and time” for the currently connected terminal ID is updated (S24). Then, the terminal connection processing ends.

In such a manner, the file server 2 obtains the obtained list information from the mobile terminal 1 when the mobile terminal 1 is connected thereto. In a case where the content file of a content output to the connected mobile terminal 1 has been updated or deleted, the file server 2 transmits information to that effect (update information or deletion information) to the mobile terminal 1. Further, in a case where the content file has been updated, the file server 2 transmits the post-update content file as well.

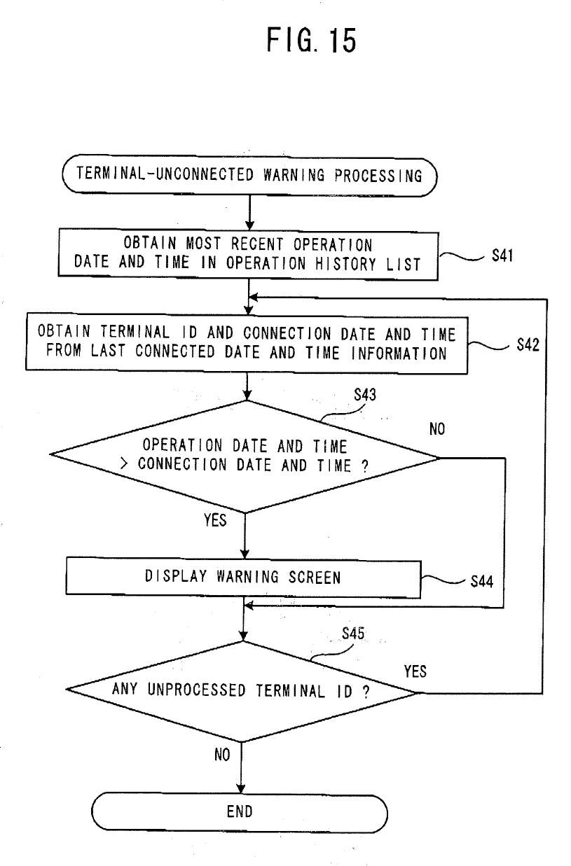

Next, terminal-unconnected warning processing will be described with reference to FIG. 15. This terminal-unconnected warning processing is performed in the file server 2 when a terminal-unconnected warning program is executed by the CPU 20. This program, which is part of the file management program, is invoked every predetermined period of time (for example, 24 hours or one hour). First, an “operation date and time” of the most recent operation history stored in the operation history list storage area 232 is obtained (S41). Then, one “terminal ID” and the “last connected date and time” associated with the terminal ID are obtained from the last connected date and time information storage area 233 (S42). Then, a determination is made as to whether the “operation date and time” obtained at S41 is larger (more recent) than the “last connected date and time” obtained at S42 (S43). That is, a determination is made as to whether a content file has been updated or deleted since the mobile terminal 1 identified by the terminal ID was connected to the file server 2 most recently. If the operation date and time is more recent than the last connected date and time (YES at S43), a warning screen appears on the display 281 (S44). On the warning screen are displayed the terminal ID and the last connected date and time and a CONFIRM button. On the other hand, if the operation date and time is less recent than the last connected date and time (NO at S43), the warning screen does not appear.

If then any one of the terminal IDs stored in the last connected date and time information storage area 233 has not been yet subjected to the processing of S42 to S44 (YES at S45), the processing returns to S42, where the unprocessed terminal ID and a last connected date and time associated with this terminal ID are read out from the last connected date and time information storage area 233 (S42). Then, the operation date and time is compared to the last connected date and time (S43) and, if the operation date and time is more recent than the last connected date and time (YES at S43), the warning screen is displayed on the display 281 (S44). If the operation date and time is less recent than the last connected date and time (NO at S43), the warning screen does not appear.

The processing of S42 to S45 is repeated in such a manner. This enables the mobile terminal 1 subjected to the update or deletion of a content file since it is last connected to the file server 2 to be notified on the warning screen. Accordingly, the manager of the file server 2 will know that the mobile terminal may have been subjected to file operations after it was last connected and so can notify the user of the mobile terminal 1 notified of to that effect, thereby calling his attention. On the other hand, the user will also know the file has been updated and so change how to use it or connect to the file server in order to obtain the post-update file. It may thus help to avoid a situation undesirable from the standpoint of internal control in which a file deleted after it had been downloaded to the mobile terminal would continue to be used.

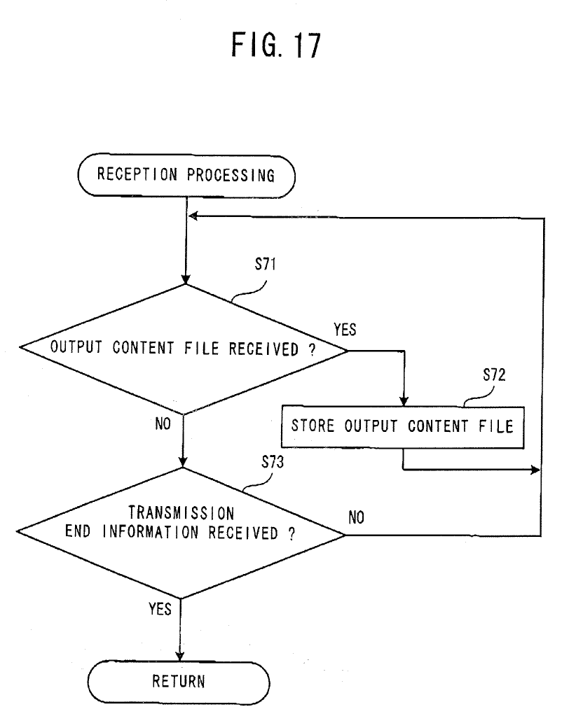

Next, a description will be given of processing which is performed in the mobile terminal 1 with reference to FIGS. 16 to 18. First, server connection processing will be described with reference to FIGS. 16 and 17. This server connection processing is performed in the mobile terminal 1 when a server connection program is executed by the CPU 10. The server connection program, which is part of a mobile terminal program, is invoked when the connection to the file server 2 is detected.

First, the terminal ID of the relevant mobile terminal 1 is read out from the terminal ID storage area 181 in the flash memory 18 and transmitted to the file server 2 (S51). Then, the output content file storage area 182 is referenced, “Content ID” and “Update date and time” for each output content file are read out, and obtained list information is created and stored in the obtained list information storage area 184 (see FIG. 10), and transmitted to the file server 2 (S52).

Then, a determination is made as to whether the mobile terminal 1 receives “end information” from the file server 2 (S53). If the mobile terminal 1 has not received the “end information” (NO at S53), a determination is made as to whether it has received “update information” (S54). If the mobile terminal 1 has not received the “update information” either (NO at S54), a determination is made as to whether it has received “deletion information” is received (S55). If the mobile terminal 1 has not received the “deletion information” either (NO at S55), the processing returns to S53 and a determination is made as to whether it has received the “end information” (S53).

The processing of S53 to S55 is thus repeated until the mobile terminal 1 receives the “update information” (YES at S54), whereupon an output content file stored in the output content file storage area 182 is replaced with the post-update output content file transmitted together with the “update information” (S56). Then, the information displayed on the electrophoretic display panel 111 is cleared, and a warning screen is displayed that indicates a message which notifies that the output content file has been updated and the content ID of this output content file (S57). Then, the processing returns to S53.

Further, if the mobile terminal 1 receives the “deletion information” (YES at S55), the content files having a content ID indicated by the deletion information are deleted from the output content file storage area 182 (S58). Then, information displayed on the electrophoretic display panel 111 is cleared, and a warning screen is displayed that indicates a message which notifies that the output content file has been deleted and the content ID of this output content file (S59). Then, the processing returns to S53.

Further, if the mobile terminal 1 receives the “end information” (YES at S53), the “update information” or the “deletion information” will no more be transmitted, so that the processing goes to S60. At this step, a determination is made as to whether a warning screen is displayed on the electrophoretic display panel 111 (S60). If no warning screen is displayed (NO at S60), it means that no change is made in the output content files stored in its own output content file storage area 182. Therefore, reception processing for receiving an output content file transmitted from the file server 2 (see S63 in FIG. 17) is performed before the server connection processing ends.

As shown in FIG. 17, in the reception processing, a determination is first made as to whether the mobile terminal 1 has received an output content file (S71). If the mobile terminal 1 has received no output content file (NO at S71), a determination is made as to whether the mobile terminal 1 has received the transmission end information (S73). If the mobile terminal 1 has not received the transmission end information (NO at S73), the processing returns to S71 to make a determination as to whether an output content file is received (S71). Then, the processing of S71 to S73 is repeated until receives an output content file (YES at S71), whereupon the received output content file is stored in the output content file storage area 182 (S72). If this output content file has a content ID that is already stored in the output content file storage area 182, the existing file is overwritten. On the other hand, if it has not been yet stored in the output content file storage area 182, an output file is newly added. Then, the processing returns to S71. Further, if mobile terminal 1 receives the transmission end information (YES at S73), no more output content file will be transmitted, so that the reception processing ends; then, the processing returns to the server connection processing, which also ends.

Further, if a warning screen is displayed (YES at S60), a determination is made as to whether the CONFIRM button has been selected (S61). This determination is repeatedly made until the CONFIRM button is selected (NO at S61, S61). If the CONFIRM button is selected at last (YES at S61), an initial screen is displayed on the electrophoretic display panel 111 (S62), and the reception processing is performed (see S63 in FIG. 17) and then the server connection processing ends.

In such a manner, the mobile terminal 1 can receive a post-update output content file from the file server 2 together with the “update information”, thereby updating the output content file stored in the output content file storage area 182. Therefore, the user of the mobile terminal 1 need not take trouble to confirm whether the content is updated to obtain it again. Moreover, a situation will be avoided in which a content file updated after it had been downloaded to the mobile terminal 1 would continue to be used. Further, the mobile terminal 1 can receive the “deletion information” to delete a content file deleted in the file server 2 also from the output content file storage area 182. Therefore, a situation will be avoided in which a content file deleted after it had been downloaded to the mobile terminal 1 would continue to be used continuously as it is. It is thus possible to avoid the situations undesirable from the standpoint of internal control.

Further, the warning screen is displayed, so that the user of the portable terminal 1 will know that an output content file has been updated. Moreover, if the mobile terminal 1 connects to the file server 2 in a condition where the pre-update content is being displayed on this terminal, the screen being displayed is cleared when the warning screen appears. Therefore, the information of a pre-update content does not continue to be displayed. In particular, in a nonvolatile display device like the electrophoretic display panel 111 of the present embodiment, what is being displayed is maintained even if power supply to the mobile terminal 1 is turned off. For example, assume that when the mobile terminal 1 is connected to the file server 2 to perform the server connection processing, power is not supplied to the electrophoretic display panel 111 if it is unnecessary. In this event, information that had been displayed before the server is connected continues to be displayed on the electrophoretic display panel 111. In this case, if the information of a pre-update content or a deleted content is being displayed on the electrophoretic display panel 111, undesirable information will continue to be displayed even if the information in the output content file storage area 182 in the mobile terminal 1 is updated or deleted. However, in the present embodiment, since the screen is cleared when a warning screen appears, the undesirable information (information of the pre-update content or the deleted content) does not continue to be displayed. Therefore, it is possible to avoid the situations which are undesirable from the standpoint of internal control. It is to be noted that if the output file is a voice, the output of the voice is stopped.

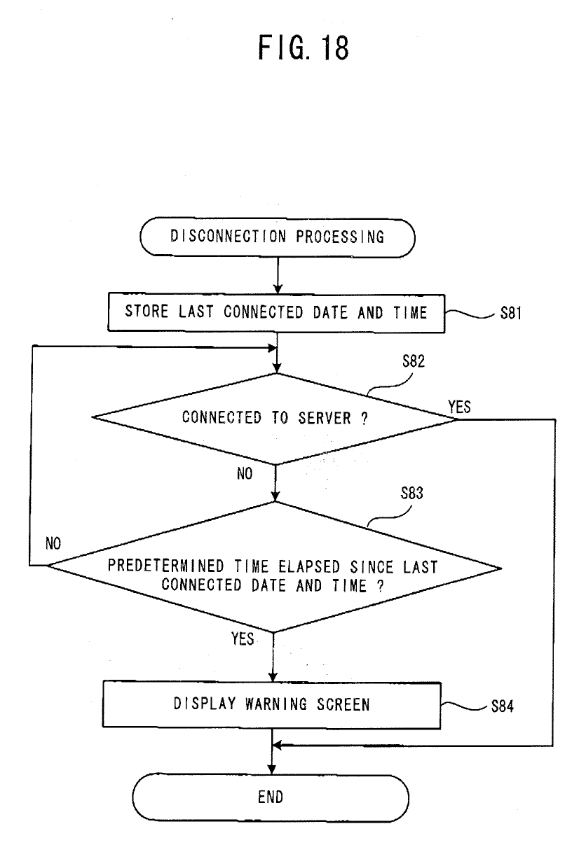

Next, disconnection processing will be described with reference to FIG. 18. This disconnection processing is performed in the mobile terminal 1 when a disconnection program is executed by the CPU 10. This program, which is part of the mobile terminal program, is invoked when a disconnection from the file server 2 is detected.

First, the current date and time is obtained from the RTC 15 and stored in the last connected date and time storage area 183 (S81). Then, a determination is made as to whether the mobile terminal 1 is connected to the file server 2 (S82). If it is not connected (NO at S82), the current date and time is obtained from the RTC 15, and a determination is made as to whether a predetermined period of time has elapsed since the last connected date and time (S83). The predetermined period of time can be set appropriately, for example, one day, five days, one week, etc. If the predetermined period of time has not yet elapsed (NO at S83), the processing returns to S82 and a determination is made as to whether the terminal is connected to the file server 2 (S82). Then, the processing of S82 and S83 is repeated until the predetermined period of time elapses (YES at S83), whereupon a warning message appears on the electrophoretic display panel 111 to notify that the terminal is not connected to the file server 2 for the predetermined period of time (S84). Then, this processing ends. Further, if the mobile terminal 1 is connected to the file server 2 while the processing of S82 and S83 is being repeated (YES at S82), disconnection processing ends.

In such a manner, if the mobile terminal 1 is not connected to the file server 2 for the predetermined period of time, the warning screen appears, so that the user of the mobile terminal 1 will know a possibility that the user might be using a file already deleted or updated. Therefore, the user of the mobile terminal 1 can change how to use a file in the mobile terminal 1 or connect to the file server 2 to obtain the post-update file. It may thus help to avoid a situation undesirable from the standpoint of internal control in which a file deleted or updated after it had been downloaded to the mobile terminal would continue to be used.

It is to be noted that the file management system, the mobile terminal, and the computer-readable recording medium recording the mobile terminal program according to the present disclosure are not limited to the embodiment above and, of course, can be changed variously without departing from the gist of the present disclosure. Although in the embodiment above the mobile terminal 1 and the file server 2 are connected through the USB cable, any other type of cable may be used. Further, the mobile terminal 1 and the file server 2 can be connected to each other through wireless communication.

Further, in the embodiment above, a content file to be output to the mobile terminal 1 is specified in the file server 2, but it may be specified in the mobile terminal 1. In this case, when the mobile terminal 1 is connected to the file server 2, a list of content files that can be output is transmitted. Then, a desired content file to be obtained may be specified in the list at the mobile terminal 1 so that the information thereof is returned to the file server 2.

Further, in the embodiment above, a content file is converted into display data in a format that can be used in the mobile terminal 1, thus creating an output content file. However, if the content file can be used as it is in the mobile terminal 1, the file can be transmitted as it is.

Further, in the embodiment above, an electrophoretic type display panel is used as the “nonvolatile display device”. However, any other type of panel, for example, a cholesteric liquid crystal type nonvolatile display panel may be utilized.

Further, in the embodiment above, a content file that is stored in the file server 2 is output to the mobile terminal 1. However, the file to be output may not be limited to a content file stored in the file server 2. For example, in a case where the file server 2 can be connected to any other apparatus over a network, the location of a content file that is stored in or can be obtained by this apparatus may be stored in the content information storage area 231 so that it is obtained and output on demand. In this case, when confirming whether the content of a content ID described in the obtained list information is either updated or deleted, the date and time when the file of that content was created might as well be referenced rather than referencing the update date and time when the operation history was updated.

Further, in the embodiment above, a terminal ID and a last connected date and time are displayed on a warning screen appearing on the display 281 at S44 in the terminal-unconnected warning processing shown in FIG. 15. However, the information to be displayed is not limited to them. For example, information (for example, user ID, name, and current department) about a person who owns the mobile terminal 1 identified by the terminal ID at the file server 2 may be stored beforehand so that the information about that person would also be displayed. Further, the history information after the last connected date and time may be also displayed.

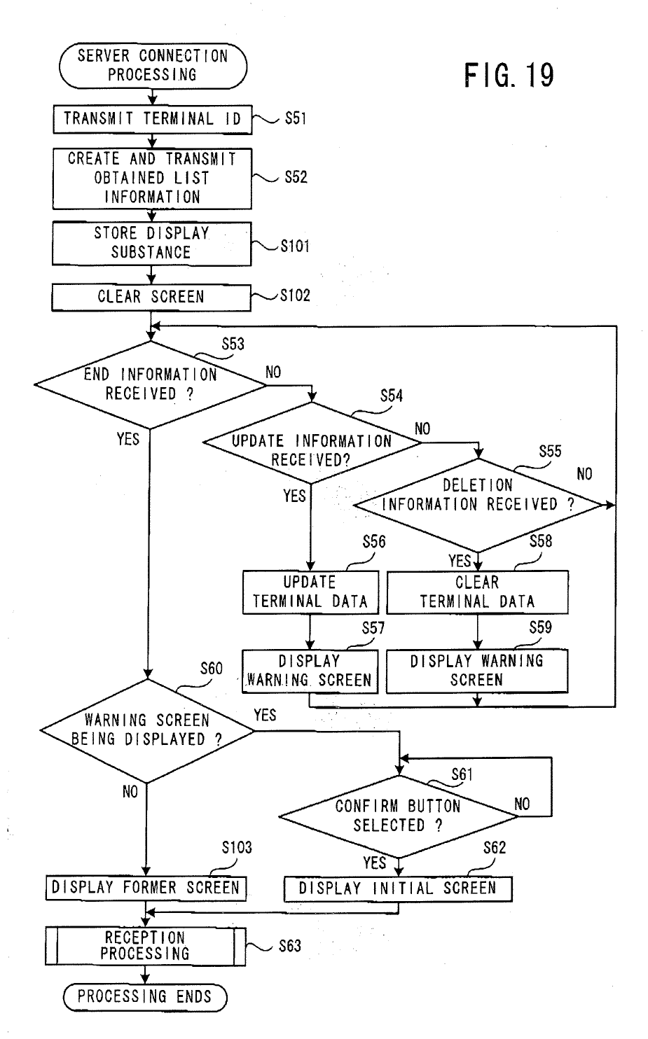

Further, in the embodiment above, information displayed on the electrophoretic display panel 111 is cleared in order to display a warning screen if the “update information” or the “deletion information” had been received. However, as shown by the flowchart of a modification of the server connection processing shown in FIG. 19, irrespective of whether the “update information” or “deletion information” is received or not, the information displayed on the electrophoretic display panel 111 may be cleared. It is to be noted that, in the flowchart shown in FIG. 19, the same processing steps as those in the flowchart of the server connection processing shown in FIG. 16 are assigned the same step numbers. The different processing steps are assigned S101, S102, and S103. In the server connection processing of the modification, after the mobile terminal 1 is connected to the file server 2, a terminal ID is transmitted (S51) and obtained list information is transmitted (S52) and then a value that indicates the information currently displayed on the electrophoretic display panel 111 is stored in a predetermined storage area (not shown) in the RAM 17 (S101). If content is being displayed, its content ID and the number of its display pages are stored. If a menu screen or a setting screen is displayed, a value indicating that menu screen is stored. Then, the screen on the electrophoretic display panel 111 is cleared (S102). Specifically, a blank screen with no character information or photos is displayed. Then, unless a warning screen due to the reception of the “update information” or the “deletion information” is displayed (NO at S60) after the end information is received, the screen stored at S101 appears again which had been displayed before the terminal was connected to the file server 2 (S103).

In such a manner, in a case where a content file is not updated or deleted, a state before the terminal was connected to the file server 2 can be inherited. However, if it is updated or deleted, the current screen is cleared and then the warning screen appears before the initial screen appears, so that even if content updated or deleted before the terminal is connected is being displayed, information thereof does not continue to be displayed. It may thus help to avoid a situation undesirable from the standpoint of internal control. Further, rather than clearing the screen as shown in the embodiment above or this modification, a determination may be made as to whether information being displayed on the electrophoretic display panel 111 is of the content indicated by the “deletion information” or the “update information” when deletion information or update information is received, so that the display may be cleared only if the information is of that content indicated by the “deletion information” or the “update information”.

Further, in the disconnection processing in the embodiment above (see FIG. 18) performed at the mobile terminal 1, only the displaying of the warning screen is displayed at S84. However, in addition to displaying the warning screen, the information of output content files stored in the output content file storage area 182 may be prevented intentionally from being displayed on the electrophoretic display panel 111. Specifically, a storage area to store a display prohibition flag is arranged in the flash memory 18. Then, before or after the warning screen is displayed at S84 or without displaying the warning screen (instead of performing the processing of S84), the display prohibition flag may be turned on (initial setting is the off-state). Then the display prohibition flag is referenced when displaying the information of output content files stored in the output content file storage area 182 on the electrophoretic display panel 111. The information may be displayed only if it is in the off-state, and the information may not be displayed if it is in the on-state. The warning screen may be also displayed in this case. Further, before or after the warning screen is displayed at S84 or without displaying the warning screen (instead of performing the processing of S84), information being displayed on the electrophoretic display panel 111 may be cleared.

While the invention has been described in connection with various exemplary structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. A file management system comprising:
a file server equipped with a file storage device that stores a file associated with an update date and time of the file; and
a mobile terminal that has a file information output device to output information described in the file and that is connected to the file server, wherein
the file server comprises:
a server-side connection device that is connected to the mobile terminal; and
a file output device that outputs the file stored in the file storage device to the mobile terminal through the server-side connection device together with the update date and time,
the mobile terminal comprises:
a display device that displays information;
a mobile terminal-side connection device that is connected to the file server;
a file obtaining device that is connected to the file server through the mobile terminal-side connection device, to obtain the file and the update date and time which have been output from the file output device;
an obtained file storage device that stores the file and the update date and time which have been obtained by the file obtaining device;
an obtained list information creation device that creates obtained list information in which file identification information to identify the file stored in the file storage device and the update date and time of the file are associated with each other; and
an obtained list information output device that outputs the obtained list information created by the obtained list information creation device to the file server,
the file server further comprises:
an obtained list information obtaining device that, if the mobile terminal is connected thereto via the server-side connection device, obtains the obtained list information from the mobile terminal; and
an update information output device that, if the update date and time of the obtained list information about the file identified by the file identification information in the obtained list information obtained by the obtained list information obtaining device is less recent than the update date and time stored in the file storage device, outputs update information which indicates that the file has been updated, to the mobile terminal, and
the mobile terminal further comprises:
an update display control device that, if having received the update information output from the update information output device in the file server, causes the display device to display a message to the effect that the file indicated by the update information has been updated.

2. The file management system according to claim 1, wherein
the file server further comprises a post-update file output device that, when the update information output device outputs the update information, outputs to the mobile terminal the file which is stored in the file storage device and which is indicated by the update information, and
the mobile terminal further comprises a file update device that, if having received the update information output from the update information output device in the file server, replaces the file indicated by the update information with a post-update file output from the post-update file output device.

3. The file management system according to claim 1, wherein the mobile terminal further comprises an output cancel device that, if the file indicated by the update information is being output by the file information output device, cancels outputting by the file information output device.

4. The file management system according to claim 1, wherein the display device is a nonvolatile display device that can maintain a display state even after power supply is interrupted,
the file information output device includes at least the nonvolatile display device, and
the mobile terminal further comprises a first display clearing device that, if having received the update information from the file server, clears display on the nonvolatile display device.

5. The file management system according to claim 1, wherein
the file server further comprises a deletion information output device that, if the file identified by file identification information in the obtained list information obtained by the obtained list information obtaining device is not stored in the file storage device, outputs deletion information to the effect that the file has been deleted, to the mobile terminal, and
the mobile terminal further comprises a deletion display control device that, if having received the deletion information output from the deletion information output device in the file server, causes the display device to display a message to the effect that the file indicated by the deletion information has been deleted.

6. The file management system according to claim 5, wherein the mobile terminal further comprises a file deletion device that, if having received the deletion information output from the deletion information output device in the file server, deletes the file indicated by the deletion information, from the obtained file storage device.

7. The file management system according to claim 1, wherein
the mobile terminal further comprises a terminal identification information storage device that stores terminal identification information to identify own mobile terminal, and
the file server further comprises:
a last connected date and time storage device that stores a date and time when the mobile terminal was last connected via the server-side connection device as a last connected date and time associated with the terminal identification information of the mobile terminal;
an operation date and time storage device that stores an operation date and time when an operation of deleting or updating the file stored in the file storage device was performed; and
a notification device that compares a most recent one of the operation date and times stored in the operation date and time storage device and the last connected date and time stored in the last connected date and time storage device to each other and, if there is the terminal identification information in which the last connected date and time is less recent than the operation date and time, notifies of the terminal identification information.

8. The file management system according to claim 1, wherein the mobile terminal further comprises a warning output device that, if a predetermined period of time elapses since connection of the mobile terminal-side connection device to the file server is disconnected, outputs a warning to the effect that it is disconnected from the file server for the predetermined period of time.

9. The file management system according to claim 1, wherein the mobile terminal further comprises an output prohibition device that, if a predetermined period of time elapses since connection of the mobile terminal-side connection device to the file server is disconnected, prohibits output of the file stored in the obtained file storage device from the file information output device.

10. The file management system according to claim 4, wherein the mobile terminal further comprises a second display clearing device that, if a predetermined period of time elapses since connection of the mobile terminal-side connection device to the file server is disconnected, clears display on the nonvolatile display device.

11. A mobile terminal comprising:
a display device that displays information;
a mobile terminal-side connection device that is connected to a file server equipped with a file storage device that stores a file associated with an update date and time of the file;
a file obtaining device that is connected to the file server through the mobile terminal-side connection device, to obtain the file and the update date and time which have been output from the file output device;
an obtained file storage device that stores the file and the update date and time which have been obtained by the file obtaining device;
an obtained list information creation device that creates obtained list information in which file identification information to identify the file stored in the file storage device and the update date and time of the file are associated with each other;
an obtained list information output device that outputs the obtained list information created by the obtained list information creation device to the file server;
an update display control device that, if having received the update information which has been created by the file server based on the obtained list information output from the obtained list information output device and which indicates that the file output has been updated, causes the display device to display a message to the effect that the file indicated by the update information has been updated; and
a file information output device that outputs the information described in the file to the display device.

12. The mobile terminal according to claim 11, further comprising a file update device that, if having received the update information output from the file server, replaces the file indicated by the update information with a post-update file transmitted from the file server together with the update information.

13. The mobile terminal according to claim 11, further comprising an output stop device that, if the file indicated in the update information is being output by the file information output device, stops outputting by the file information output device.

14. The mobile terminal according to claim 11, wherein
the display device is a nonvolatile display device that can maintain a display state even after power supply is interrupted,
the file information output device includes at least the nonvolatile display device, and
further comprising a first display clearing device that, if having received the update information from the file server, clears display on the nonvolatile display device.

15. The mobile terminal according to claim 11, further comprising a deletion display control device that, if having received the deletion information which has been created by the file server based on the obtained list information output from the obtained list information output device and which indicates that the file output has been deleted, causes the display device to display a message to the effect that the file indicated by the deletion information has been deleted.

16. The mobile terminal according to claim 15, further comprising a file deletion device that, if having received the deletion information output from the file server, deletes the file indicated by the deletion information from the obtained file storage device.

17. The mobile terminal according to claim 11, further comprising a warning output device that, if a predetermined period of time elapses since connection of the mobile terminal-side connection device to the file server is disconnected, outputs a warning to the effect that connection to the file server has not been performed for the predetermined period of time.

18. The mobile terminal according to claim 11, further comprising an output prohibition device that, if a predetermined period of time elapses since connection of the mobile terminal-side connection device to the file server is disconnected, prohibits output of the file stored in the obtained file storage device from the file information output device.

19. The mobile terminal according to claim 14, further comprising a second display clearing device that, if a predetermined period of time elapses since connection of the mobile terminal-side connection device to the file server is disconnected, clears display on the nonvolatile display device.

20. A computer program product comprising a computer-readable medium recording computer readable instructions, wherein execution of the computer readable instructions causes a controller of a mobile terminal having a display device to perform the step of:
connecting the mobile terminal to a file server equipped with a file storage device that stores a file associated with an update date and time of the file;
obtaining the file and the update date and time from the file server;
storing the file and the update date and time which have been obtained;
creating obtained list information in which file identification information to identify the file stored in the file storage device and the update date and time of the file are associated with each other;
outputting the obtained list information to the file server;
if having received the update information which has been created by the file server based on the obtained list information and which indicates that the file output has been updated, causing the display device to display a message to the effect that the file indicated by the update information has been updated; and
outputting the information described in the file to the display device.
